(19) United States
(12) Patent Application Publication
(10) Pub. No.: US 2012/0151402 A1
(43) Pub. Date: Jun. 14, 2012

(54) Lifecycle Management of Enterprise Boundaries

(75) Inventors: Jayson Durham, Lakeside, CA (US); Nolan D. Cmerek, Houston, TX (US)

(73) Assignee: United States of America, as Represented by the Secretary of the Navy

(21) Appl. No.: 12/571,237

(22) Filed: Sep. 30, 2009

(51) Int. Cl. G06F 3/048

(52) U.S. Cl. 715/772

(57) ABSTRACT

An enterprise management technique is used to manage resolution or execution of a resolution. An infrastructure is selected as a given basis for an enterprise architecture, and a discrepancy, problem, need, goal or other task is identified as a resolution object, and a determination is made whether the resolution object has validity as a resolution object to be addressed by the organization. A minimum set of individuals or stakeholders is identified as a sub-group to address or execute the resolution object based at least in part on the selection. A measurement characteristic is identified and a protocol for approval of the selection is followed. The progress of the sub-group in the addressing or execution of the resolution object is monitored by monitoring the measurement characteristic.

### FEDERALLY-SPONSORED RESEARCH AND DEVELOPMENT

This invention (Navy Case No. 099522) was developed with funds from the United States Department of the Navy. Licensing inquiries may be directed to Office of Research and Technical Applications, Space and Naval Warfare Systems Center, Pacific, Code 72120, San Diego, Calif., 92152, telephone (619) 553-2778; email: T2@spawar.navy.mil.

### BACKGROUND

An Enterprise Architecture (EA) is an operational model for managing activities (e.g., processes, services) within an enterprise. A Service Oriented Architecture (SOA) is a computer architecture which, when defined in its own standalone-context for a business domain, provides a set of principles and generic interfaces (i.e. services) for implementing governing concepts and managing changes while taking such principles and services through to realization. The presently disclosed subject matter leverages and extends the emerging Enterprise Architecture (EA) and Service Oriented Architecture (SOA) framework technology and its associated methods of service discovery, orchestration and object resolution.

### SUMMARY

A technique for managing an enterprise is implemented by identifying a discrepancy, problem, need, goal or other task as a resolution object. An infrastructure is selected as a given basis for an enterprise architecture, and a determination is made if the resolution object has validity, i.e. whether as a resolution object needs to be addressed. A minimum set of individuals or stakeholders is identified as a selection and a sub-group is formed to address or execute the resolution object. A measurement characteristic is identified and progress of the sub-group in the addressing or execution of the resolution object is monitored.

### BRIEF DESCRIPTION OF THE DRAWINGS

The novel features of the present invention will be best understood from the accompanying drawings, taken in conjunction with the accompanying description, in which similarly-referenced characters refer to similarly-referenced parts, and in which:

FIG. 1 is a diagram showing an organization or network and the operation of the program within the organization or network;

FIG. 2 is a diagram showing the steps of an exemplary operation of the Lifecycle Management of Enterprise Boundaries (LMEB) technique, according to several embodiments of the present invention;

FIG. 3 is a diagram showing a sensor network employing a technique according to some embodiments of the present invention;

FIG. 4 is the same diagram as FIG. 3, but with the sensor nodes self-synchronized.

FIG. 5 is the same diagram as FIG. 3, but with the sensor nodes returned to their baseline mode of operation after the self-synchronizing sub-group has dissolved;

FIG. 6 illustrates how different nodes and end users can interact with the subnet via their own respective interface;

FIG. 7 is the same diagram as FIG. 6, which shows the layers provided by the Persistent Architecture Framework in greater detail;

FIG. 8 is a diagram that illustrates the Persistent Enterprise Architecture Framework (PEAF);

FIG. 9 is a diagram of an embodiment where the PEAF and nodes share a services layer of architecture;

FIG. 10 is the same diagram of FIG. 9, but the nodes shown in a self-synchronizing mode; and,

FIG. 11 is a diagram of the LMEB according to several embodiments of the present invention, wherein sensors have self-synchronized and accomplished the techniques described in FIG. 2.

### DETAILED DESCRIPTION

Overview

The present system and methods according to several embodiments of the present invention address a need of the operational and tactical community to gather accurate data. Related, yet distinctly different, elements according to this disclosure are in early intelligent robotics papers. In particular, a pre-cursor concept to several systems and methods of the present invention is the notion of a plan-execution system, described in Jayson Durham et al., entitled Eave-West: A Testbed for Plan Execution, Naval Ocean Systems Center, San Diego, Calif., USA, Proceedings of the 1987 5th International Symposium on Unmanned Untethered Submersible Technology, June, 1987, vol. 5, pp. 33-43. That document describes how the mission-level goals of an unmanned platform can be represented as an interdependent aggregate of a hierarchically structured collection of a small number of data types (e.g., tasks and events). The current disclosure extends such methods and tools of plan execution to enable the self-synchronization of a dynamically assembled collection of self-organized enterprise agents from an organization (either human or machine/virtual, or mixtures thereof).

Another early publication highlights the ability to embed multiprocessing technology throughout a distributed network of mission-related activities, including on-board the individual platforms/nodes. This ability is described in Jayson Durham, et al., A Testbed Processor for Embedded Multi-Computing, Naval Ocean Systems Center, CA, Proceedings of the 6th International Symposium on Unmanned, Untethered Submersible Technology, June 1989, pp. 320-330. The current disclosure further extends such capabilities to include the use of distributed computing resources that provide a unified collection of (human or virtual) end-user interfaces (e.g., dashboards, portals, gateways) whereby a collection of processing resources and associated tools enable triggering of the self-organization of enterprise agents and associated enterprise services and resources (e.g., computational services and assets). Thus, the presently disclosed subject matter leverages the recent developments of Enterprise Architecture (EA) frameworks and Service Oriented Architecture (SOA) tools and services to provide a novel and non-obvious means for enabling a mode of enterprise operation whereby a priori enterprise objectives and plans are dynamically compared against the current state of an enterprise and respective sub-entities (e.g., organizational units and associated agents).

Through automated interaction with the respective enterprise agents and computational services/resources, this new distributed multiprocessing device enables the persistent enterprise architecture to initiate interaction with the respective enterprise agents to enable the self-organized creation of a new organizational sub-structure (e.g., sub-network, integrated product team, ad-hoc committee). The sub-structure in turn updates enterprise plans (e.g., COA—courses of action) that better reflect the payoff and benefit to the overall mission goals and objectives of the enterprise and respective participating stakeholder agents (human and virtual). It is noted that the virtual/machine components include the codification of behaviors and services that may have previously required manual labor or intellectual capital implicit to the human enterprise agent. The utilization of machine planning, enterprise optimization, and analysis capabilities is included in both the centralized self-organization collaboration support service/server and within each respective participating enterprise entity (i.e., service participant).

In several embodiments of the present invention, the present system provides a Lifecycle Management of Enterprise Boundaries (LMEB) technique which is useful for managing an organizational structure of an enterprise. In other embodiments, the technique uses a business model and automates a process of enterprise organization (and reorganization of the organization) based on the LMEB.

One aspect of the LMEB technique is that the technique facilitates “self-synchronization” of subgroups within the enterprise. Self-synchronization is viewed as an essential process within military and other organizations to increase speed of command and accelerate execution of mission goals. Self-synchronization is described in Hutchins et al., Enablers of Self-Synchronization for Network-Centric Operations: Design of a Complex Command and Control Experiment, Naval Postgraduate School, Monterey, Calif. 93943 (2001). For purposes of this disclosure, and as described in Hutchins et al., self-synchronization is, “the ability of a well-informed force to organize and synchronize complex warfare activities from the bottom up. The organizing principles are unity of effort, clearly articulated commander's intent, and carefully crafted rules of engagement.” Significant features and elements of this type of self-organizational phenomena have also been observed in some naturally occurring organizational structures, such as ant colonies: “Activity patterns are not just synchronized, but self-synchronized: no external signal has been found experimentally as a possible cause of colony synchronization. Thus, self-synchronization of subgroups is achieved in which two or more agents (i.e., human or virtual) self-organize due to their own self-interests.

Self-synchronization is the process whereby an organizational topology provides network connectivity and organizational structure of entities and respective services and dynamically changes based on objectives and associated features of individual and sub-group nodes. This presents an ad-hoc collection of enterprise entities that dynamically self-organizes, and can be human, virtual or a mixture of human and virtual. The technique described herein provides a mechanism that enables an EA/SOA framework to indigenously support more automated methods-of-doing-business (i.e., default organizational behaviors) that exhibits such qualities of collective self-synchronization. Self-synchronization provides an ability to build the self-organized subgroup into the enterprise's infrastructure. As a result, the self-synchronization is used as a means to more directly manage and organize organizational boundaries. Examples of organizational boundaries include data flow, business rules and control flow, policy jurisdiction/management and contextual roles and responsibilities.

Organizational structure can be dynamically determined by the LMEB technique. Functionally derived structure is determined by stakeholders, based on goals and objectives, and within the limitations of resources. Business management rules are then able to be used as the basis for policy management when implementing the LMEB technique. Collaboration of management to establish a policy of management is achieved with messages pertaining to the organizational structure, including changes relevant to goals and objectives.

Through a distributed collaborative exchange of messages and interaction, the respective enterprise entities may separately identify additional candidate services and associated providers, as well as collectively determining the entities not to be included. This bootstrapping of an initial self-assessment of basic service-provider aggregation with service capabilities of other entities within the enterprise is used to provide the LMEB capability. The logically centralized LMEB service facilitates and enables this collective interaction and helps ensure that the respective information element updates, such as business rules are distributed or centralized as needed for progressing to the next phase of collective resolution analysis, planning, and plan execution within this newly established organizational context that directly impacts the resulting changes in individual roles and responsibilities of the respective individual service-provider entities. Information element updates may include business rules, data and metadata, or data that describes and pertains to other data (such as metatags within an .html context, for example). The resulting changes may include reconfiguration. The individual roles and responsibilities are modes of operation.

Architecture, as used in this description, is an artifact of a modeling process or methodology. For the purposes of this disclosure, an Enterprise Architecture (EA) is the net collection of modeling artifacts that are associated with the use of a given process or methodology. By definition of EA/SOA framework principles, the EA/SOA artifacts are the conceptual models that represent the essential features and qualities of the functional executed behaviors. Thus, EA/SOA frameworks are an example of hierarchical model-driven conceptual and logical frameworks that map to a physical substrate (human and virtual machine infrastructure) that work towards a collective enterprise mission goal that directly correlates in principle with the goals of the respective aggregated enterprise entities.

Within a growing spectrum of organizational enterprises (e.g., industry, academia, and government), the concept of an Enterprise Architecture (EA) has recently become the operational paradigm for better management of activities (e.g., processes, services) and associated interdependencies (e.g., activity models and process threads), within the context of their underlying information technology (IT) infrastructure. Thus, EA reflects a more process-oriented and mission-driven approach towards the integration and standardization of an organization's operating model than would be achieved by human ad-hoc management techniques.

The primary purpose of creating an EA is to ensure that business strategy and IT infrastructure investments are aligned and facilitate traceability from the business strategy down to the underlying business processes and technology infrastructure. Within the EA/SOA context, services are dynamically composed and orchestrated for execution of respective business processes and activities. Thus, the LMEB service is an example of a self-orchestration support activity whereby the collective behavior of the ad-hoc collection of entities is self-organizing due to collective a priori objectives and internal entity constraints (e.g., business rules). This self-synchronous behavior is an event-driven process that is an artifact of the inherent structure of the LMEB-enabled EA/SOA framework construct.

For purposes of this description, an enterprise is a unit of organization or activity, especially an economic or business organization. The notion of an “enterprise” is generally understood as having emerged from the economic and business application domains and since has become associated more generally with the notion of units of organization or activities from which there is an underlying model of such entities, their interaction, and associated persistent context (e.g., environment). “Units of organization” are herein considered to be defined according to observed or implied attribute categories, such as those associated with economics and organizational well-being. Thus, enterprises are constituted and persist for economic and other reasons.

It is noted that the presently disclosed subject matter enables the decoupling of organizational and physical structure from functional objectives and enables the organizational structure to be a dependent variable of the respective overarching dynamic aggregation of enterprise entity objectives. Examples of enterprise entity objectives are entity/agent purpose of execution or operation. Thus, the enterprise infrastructure is able to dynamically self-manage the organizational structure of the enterprise based on dynamics associated with the collective behavior of the organization. Where an ad-hoc collection of enterprise entities exhibit patterns of behavior that organically merit self-organization, the enterprise framework is structured and pre-configured to support this mode of purposeful behavior. A specific non-limiting example of this LMEB capability is discussed as an example of this type of EA/SOA framework capability.

The nature and type of the modeling activity for EA is commonly held in contrast to the specific design and engineering of a particular enterprise. The historical analogy to the construction industry illustrates how one first works with an “architect” to understand and appreciate what one is looking to engineer and build. The modeling processes for the design and construction of enterprises and their various components, are historically separate from the focus and intent of EA. For example, the U.S. Department of Defense (DOD) Architecture Framework was originally created within this more sequential lifecycle process. The Department of Defense Architecture Framework (DoDAF) provides a foundational IT framework for developing and representing architecture descriptions that ensure a common denominator for understanding, comparing, and integrating architectures across organizational, joint, and multinational IT boundaries. It establishes data element definitions, rules, and relationships and a baseline set of products for consistent development of systems, integrated, or federated architectures. These architecture descriptions may include Families of Systems (FoS), Systems of Systems (SoS), and net-centric capabilities for interoperating and interacting in the Network Centric Environment (NCE). The DoDAF was originally developed to define and develop a better means and process for ensuring that DoD C4ISR (Command, Control, Communications, Computers, and Intelligence, Surveillance, and Reconnaissance) capabilities were interoperable and met the needs of the warfighter.

With the advent of globally inter-connected persistent enterprise infrastructures and associated frameworks, the Department of Defense Architectural Framework (DoDAF) has undergone a major revision to provide a means for supporting the standardized modeling of the “as-is” (current state) and “to-be” (desired state) composition of enterprises within the context of their individual and collective purpose (i.e., mission). Thus, the use of the term “architecture” has evolved and will continue to evolve towards a more all-encompassing modeling process. The value of EA/SOA frameworks is to enable the re-engineering of business processes and associated infrastructure to maximize competitiveness and successful enterprise mission execution. Thus, EA/SOA artifacts are created to model both the as-is condition of the enterprise and the to-be desired resulting entity. Given these two models, a transition plan is developed for facilitating the transition of the as-is to the transformed to-be construction.

Historically, the focus of the systems engineering (e.g., DODAF) process was oriented towards sequential development of “stove-piped” stand-alone systems. An analogy often used is “software as a shrink wrapped product” versus “software as a service.” The EA/SOA service-oriented approach better reflects the fact that enterprises (and the valuable services the enterprises provide) evolve and transform over time to maximize the enterprise success. The presently disclosed subject matter provides a mechanism for providing an added degree of agility and responsiveness by better enabling dynamic self-synchronization capabilities.

A Service Oriented Architecture (SOA) is a computer architecture which, when defined in its own standalone context for a business domain, provides a set of principles for governing concepts and associated services, and changes while taking them through to realization, An SOA provides interoperable services functionality, as well as the interdependencies that may be associated with the service functionalities. For EA, the focus and intent of the modeling has continued to evolve towards the organization and description of “enterprise services”. Thus, most recently, EA is generally associated with Service Oriented Architectures (SOA) whereby there are specific constraints on the underlying models, such as the notion of a “services stack”; persistent infrastructure framework; interoperability through common interfaces that decouple specific implementations of such services; and discovery and use of interoperable interfaces. Indeed a key goal of SOA is to foster competition for Commercial-Off-The-Shelf (COTS) and Government-Off-The-Shelf (GOTS) commodity resources within the marketplace for the availability of specific services, while at the same time hiding the vendor and associated technology details from the execution of the enterprise business and mission goals. Introductions and reviews of SOA are widely available.

More recently, related but different elements according to this disclosure are, in principle included with the mission and vision of the Sensor-net Self-Organization and Control (SenSOC) initiative. The features of SenSOC publicly disclosed to date are described in Jayson Durham et al., Net-Centric Human-Robotics Operations: Integration Of Business/Military Process Management, Grid Computing, And Robotics, Proceedings IEEE International Conference on Web Services, 2004, pp. 810-811. This reference states the desire for “human-robotics operations” but does not include descriptions of mechanisms that enable self-synchronization. The presently disclosed subject matter provides a mechanism for self-synchronization that assumes a heterogeneous ad-hoc collection of human and virtual enterprise entities such as services, agents and sensors. One goal of SenSOC is to discover and develop devices and methods whereby the tenet of self-synchronization can be realized. The SenSOC initiative did not go so far as to describe a technique of self-synchronization of organizational boundary management.

The presently disclosed subject matter leverages and extends the emerging Enterprise Architecture (EA) and Service Oriented Architecture (SOA) framework technology and its associated methods of service discovery, orchestration and mediation. This results in a dynamic configuration and management of ad-hoc EA/SOA subnets to a single dynamically determined EA/SOA subnet within an overarching network. “Dynamic configuration management” is the pre-configured enterprise structure that enables ad-hoc collections of enterprise entities to self-encapsulate and interact with the externalized enterprise entities as a more singular self-organized entity. Thus, the ad-hoc subnet is able to form a more tightly bound and tailored collective within an enterprise state having multiple objectives and constraints. The subnet allows the overarching network to interact with the subnet more as a single node operating under a more tightly controlled mode of operation (e.g., by applying a distributed control algorithm). The single node more closely monitors the dynamics of said subnet for execution of a collective goal/purpose/milestone. The subnet itself can further identify and monitor conditions so that it can return to a baseline mode of operation. As a result, the nodes of the subnet are more individually managed as prior to their reorganization.

Addressing a Problem, Task or Procedure

Addressing a problem, task or procedure can comprise the steps of identifying a system or infrastructure, recognizing a discrepancy, problem, need, goal or other task, defining it as a task, engaging in the task to address the defined need or goal, and creating a resolution to the need or goal. There may be more steps, such as marketing and funding, but the overall operation is one of going from need to resolution.

Taking the case of an intermittent windshield wiper on an automobile (as a hypothetical case; not the actual patented invention), it can be presumed that the basic system or infrastructure existed, which would be an automobile with an electric windshield wiper. The car presumably functions as intended, but without the intermittent wiper, the driver's options would be to either select an operating speed for the wiper for continuous operation, or manually cycle the wiper control switch. Thus, if continuous operation were not desired, the driver could switch the wiper on and off periodically or tolerate the continuous operation. Cycling the wiper switch on and off would be a minor distraction or source of irritation. The “need or goal” would be to cause the wiper system to perform the task of cycling the switch. This cycling of the switch according to a desired time interval would be recognized as a goal or resolution object.

Continuing with the windshield wiper analogy, the presently disclosed subject matter enables a vehicle to be built wherein each of the entities are service-oriented subcomponents within a System-of-Systems (SoS) vehicle configuration. Within this type of framework (e.g., a SoS configuration), a logically centralized LMEB service enables the ability to further introduce an overall car-driver enterprise objective of minimizing the interaction with the driver that in turn can trigger a cascade of interactions such that the aggregated elements that produce this activity are able to more cohesively work together to optimize the resulting behavioral goal. This added computational framework capability enables the potential configuration whereby an after-market moisture sensor or windshield sensing capability can, in principle, be more easily connected to the intermittent windshield wiper control circuit to modulate the frequency of intermittent wiping activity, while monitoring the preference indicated by the driver's feedback (or lack of feedback for when performance is satisfactory). Thus, this simple notional example highlights a LMEB enabled ability for the respective entities of the car-driver enterprise to readily self-synchronize through the mutual interest in minimizing driver interaction and maximizing driver satisfaction for intermittent windshield wiper activity (i.e., service). Note that for this disclosure, a novel feature of this extended EA/SOA framework is the ability to dynamically reconfigure the roles and responsibilities (i.e., organizational structure) of the enterprise entities, based on a generalized and potentially dynamic assortment of enterprise objectives/goals.

The generalized ability of LMEB is illustrated by the analogy to reorganizing wiper control responsibilities. Thus, the engaging of the task and creating a resolution comprises designing a timer circuit, building the timer circuit and modifying car windshield wiper controls to incorporate the additional switch function and timer circuit. Thus an automatic function, typically engagable from the wiper switch, is used to address the problem and substitute that automatic function for manually cycling the wiper switch. Furthermore, other enterprise services/capabilities, such as a moisture sensor, can be discovered by a logically centralized LMEB service and further associated to an enterprise goal of minimizing driver interaction and enabling a further off-loading of driver bandwidth/activity associated with optimized windshield wiping frequency.

Variants of the service-providing functionality of the service-provider entities may be introduced to better match the potential collective interaction of the said service entities. These “cross-cutting concerns” (concerns that affect service functionalities when considered in the aggregate), called “aspects” in computer science, are introduced at the earliest possible time within the LMEB reorganization process. This helps optimize the follow-on synchronization and related potential interdependencies between the respective services.

Using an Enterprise Architecture (EA) for Problem Solving

In the more general case of an enterprise, it is presumed that an enterprise or a segment within the enterprise exists, and comprises people or people and equipment. The enterprise or segment within the enterprise addresses various discrepancies, problems, needs, goals or other tasks. Such discrepancies, problems, needs, goals or other tasks are referred to herein as “resolution objects”. If a particular resolution object is to be addressed, the enterprise or segment within the enterprise may be called upon or otherwise function to address the particular resolution object. In some cases, the entire enterprise or segment within the enterprise addresses the resolution object, whereas in other instances, only a portion of the entire enterprise addresses the resolution object.

In cases where a resolution object is addressed by fewer than the entire enterprise or enterprise segment, the sub-group which addresses the object is a defined part of the organizational structure of the enterprise. This sub-group may be “officially” assigned the task, but sometimes the sub-group gets together without a formal assignment of duties. For example if a light bulb needs changing and there is no fixed procedure for doing so, one person may change the light bulb. If ladder work is involved, perhaps the person changing the light bulb may solicit help from others. If the sub-group assembles on its own, rather than following direct orders from a supervisor, the workgroup for changing the light bulb forms a self-synchronizing mechanism which self-synchronizes the organization.

In a typical case, self-synchronization is performed without outside help; however in the case of organizations employing the use of expert systems or performing activities involving a need for structured supervision, there would be advantages in efficiency and effectiveness of the enterprise or enterprise segment if the self-synchronization process can be automated and/or monitored.

Automation Supervised Establishments of Sub-Groups

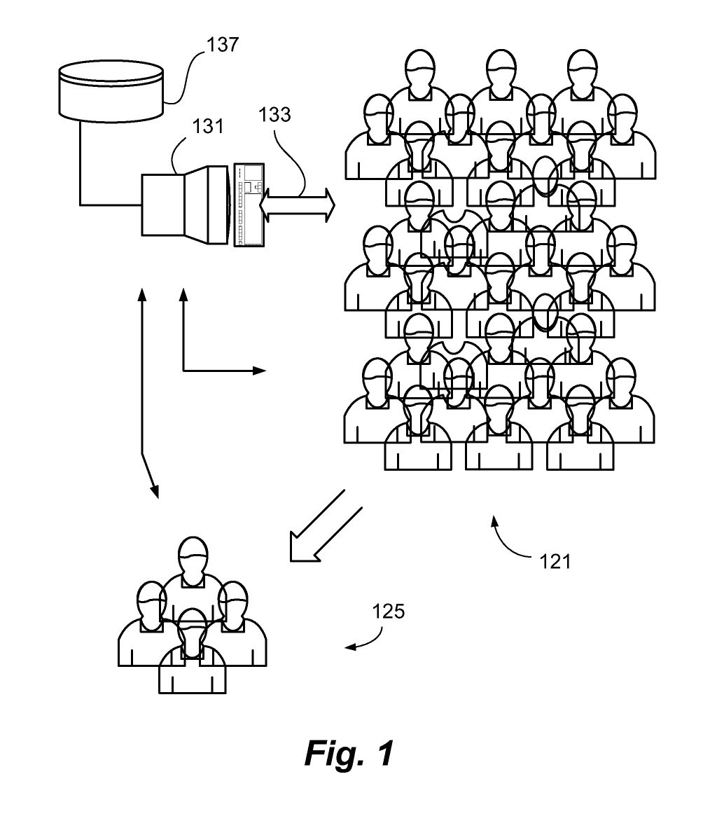

FIG. 1 is a diagram showing the operation of the LMEB in establishing sub-groups and monitoring the organizational structure of the EA. Depicted are a group of individuals 121, who can make up an enterprise or a portion of the enterprise. In order to address a resolution object (which has previously been defined according to several embodiments), a sub-group 125 of the group 121 may perform the tasks necessary to address the resolution object. The sub-group may be self-selected or selected by a supervisory authority based on aptitude in addressing the resolution object. For example, if the resolution object is to identify which of a listing of telephone numbers is a square root of a prime number, the sub-group 125 could be people who are good at math or at finding prime numbers. The task would be undertaken by the sub-group. If the sub-group 125 self-selects, this procedure is considered self-synchronization because the organization 121 adapts to the resolution object. In this example, the sub-group 125 would determine that none of the telephone numbers in the phone book meet the specification, which also permits those member of group 121 that are not in sub-group to continue 125 to not expend any effort in addressing that particular resolution object.

The LMEB includes organization functions computer 131, which includes an interface 133 between computer 131 and group 121, and further a processor that selectively accesses database 137. The LMEB is able to facilitate the formation of the sub-group 125 by interacting with the enterprise 121 in the formation and maintenance of the sub-group 125. The interaction is with the enterprise 121 as a whole and with the sub-group 125.

Establishing an Enterprise Architecture (EA) Subgroup

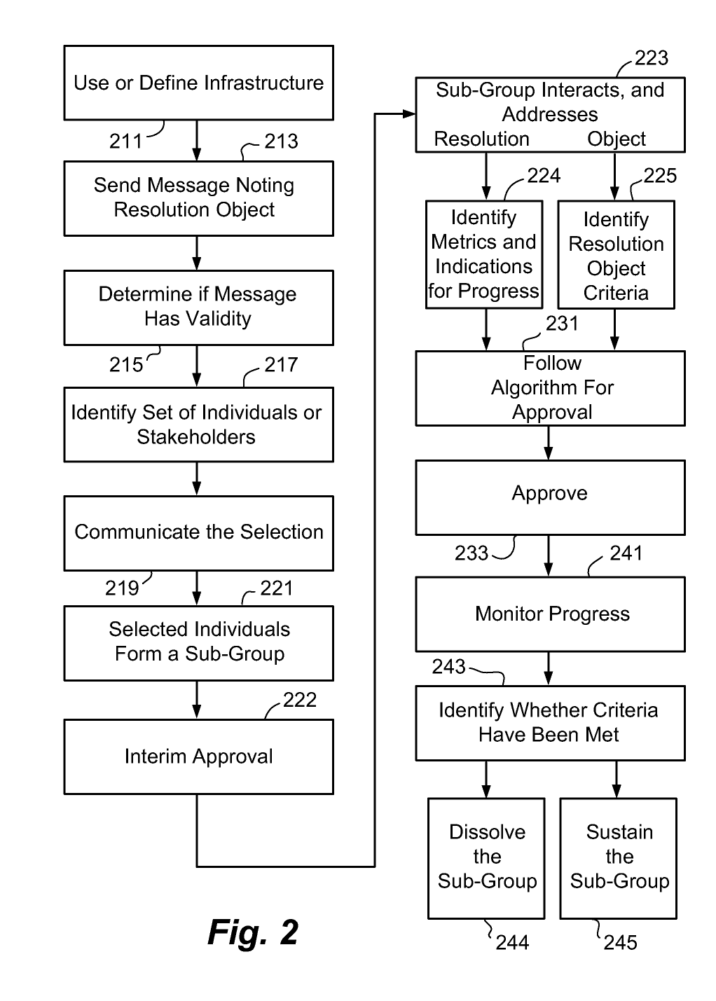

FIG. 2 is a diagram showing an example algorithm of the LMEB, including the establishment of an EA subgroup. The algorithm may be described as follows, with a more detailed discussion of the various components of the algorithm found below:
1. Define an infrastructure as a given basis for the EA, represented by step 211.
2. Send a message noting a resolution object, represented by step 213.
3. Validate or compare with a database to determine if the message in step 213 has validity as a resolution object to be addressed by the organization, represented by step 215.
4. Identify a minimum set of individuals or stakeholders as a selection, represented by step 217. The logically centralized LMEB service tracks the competencies, roles, and responsibilities of the respective entities that are within the potential scope of the respective overarching enterprise group 121. The competencies can be tracked by computer 131 or informally within group 121 or sub-group 125. Thus, the mapping of goals and objectives, competencies, and physical activities is logically represented within the operational context of the LMEB service. Note that the physical storage and execution of the LMEB service may (or may not) be distributed across an aggregate collection of LMEB subcomponents. Thus, the LMEB facilitates the association of a minimal set of competencies and their associated agents to address successful execution of an enterprise goal. Expert systems and mission planning software are common embodiments of this type of capability.
5. Communicate the selection of individuals or stakeholders as a sub-group, represented by step 219. The LMEB facilitates collaborative interaction among the respective enterprise service providing entities. Changes in organizational structure are identified (e.g., roles, responsibilities, policies, business rules, jurisdictions, etc.), relative to the entities identified.
6. Selected individuals accept or decline or are accepted or declined by a supervising authority, thereby forming a sub-group, represented by step 221. Each enterprise service providing entity independently assesses the merit and feasibility of the proposed changes and either accepts or declines to further engage in addressing of the resolution object. A meta-process can typically also provide a “check and balance” whereby the final selection of associated service providing entities for organizational changes is committed. In this manner, the sub-group 125 composition attains interim approval, either by the group 121, by computer 131, or even by the sub-group itself 125, as indicated by step 222.
7. Sub-group 125 interacts, provides decision and identifies courses of actions, represented by step 223. This step has two sub-steps, as indicated in FIG. 2:
   7a. Metrics and indications for object resolution progress can be indicated, as represented by step 224; and,
   7b. Criteria for object resolution and for dissolving sub-group 125 can be defined, represented by step 225.
8. Follow protocol for approval, represented by step 231.
9. Receive approval, represented by step 233.
10. Monitor the progress of the sub-group, represented by step 241.
11. Identify whether criteria have been met (step 243) to dissolve the sub-group, represented by step 244 or to sustain the sub-group, represented by step 245. A number of possible means exist for initiating an assessment of an aggregated encapsulation of services that are working more collectively and cohesively to optimize and achieve an enterprise goal/objective, or resolve conflicting enterprise goals and associated conflicting activities. Typically a hybrid of “bottom up” and “top down” hierarchical (i.e., resource management associated meta-processes) interaction facilitates the final assessment.

The above procedure results in the defining of a sub-group and its subsequent implementation. The sub-group is defined, identified, created, performs its functions, monitored and either dissolved or sustained. This results in a dynamic re-organization of the enterprise or enterprise segment to include the sub-group. To the extent that the procedure is integral with the function of the enterprise or enterprise segment, the procedure results in a self-synchronization of the enterprise or enterprise segment, in this case with the help of the logically centralized LMEB enterprise services.

To discuss the above-cited steps in FIG. 2 in more detail, to accomplish step 211, it is necessary to start with a basic organization or infrastructure, much like the manner in which the development of the intermittent wiper control cited above started with a functional automobile with a functional electric wiper. The basic organization or infrastructure becomes a baseline. The basic organization or infrastructure forms the basis for the EA because without the infrastructure, the EA would have no meaning. Part of the infrastructure is an organization functions computer, which performs supervisory tasks related to the monitoring of the organizational structure of the enterprise, enterprise segment or sub-group 125. The organization functions computer need not have control over the operation any more than any other automated device; rather it provides information to human and virtual users (i.e., consumers and producers of services) in the enterprise, maintains a database and compares data received to data in the database to render outputs relevant to the data. An example would be identifying a task as part of a particular category of tasks, and searching the database for individuals with aptitude or interests relevant to that category of tasks. The server provides messages pertaining to the organizational structure, including changes relevant to goals and objectives. The messages pertain to the organizational structure, and include changes relevant to goals and objectives. Collaboration of management with policy management is thereby achieved with the messages.

Other mechanisms can provide the same functionality of the organization with the system and methods of several embodiments as functions computer 131. Examples include: 1) A back end server, which provides information to a primary stakeholder. This is accessed through a portal, widget or “dashboard” provided as a human (or virtual user) interface to control the organization functions computer; or, 2) A subgroup within the organization initiates change and announces the change. Then the change is either agreed upon or declined by the organization as described in steps 221, 222 and 233.

The topology (i.e., network connectivity and organizational structure of entities and respective services) of jurisdictions and overall structure is dynamic. The server and respective stakeholders (i.e., enterprise entities) dynamically share information.

In step 213, a message noting a resolution object is sent. This can be a message between members of the enterprise, from an outside stakeholder, from an outside source other than a stakeholder to a member of group 121 or sub-group 125, or from a sensor capable of providing a signal to group 121 or sub-group 125. Normally the message would come from a part of the enterprise, but it is possible that the only connection between the source of the message and the enterprise is the message.

In step 215, the validation is used to determine if the message has validity as a resolution object. If the message is of the nature of a general complaint or comment, such as, “I don't like the weather” or “this task is tedious”, then that may not be an issue to be addressed by the enterprise or enterprise segment. Similarly, the organization functions computer 131 can parse the message to determine if the message is relevant to organizational tasks in the organization functions computer's database. In some cases the messages are presumed valid, but in other cases, it is necessary to validate or compare the messages by use of a database to determine if the message noting a resolution object has validity as a resolution object to be addressed by the organization.

In step 217, a minimum set of individuals or stakeholders is identified as a selection. The selected stakeholders can be “virtual stakeholders”, in that they do not have to be located at the same location. This is the proposed sub-group in the organizational structure; however, it may be that some of the individuals will eventually either decline or be de-selected. It is also possible that other individuals will join the sub-group. This is a potential ad-hoc network of enterprise entities (e.g., sub-group or subcommittee which include virtual service providers/consumers) to perform the course of action for addressing the resolution object. The identification of such entities may be performed based on profiles and associated information. This data will be compared to the information in the database concerning the category of tasks. In order to accomplish this, the organization functions computer must receive data concerning the service capabilities of the group 121, and it must further be able to compare this data concerning the individuals to the data required to address the resolution object.

In step 219, the selection of individuals is communicated to the individuals, to a human supervisor, or to both. The implication is that: 1) A task has been identified; 2) these individuals appear to have the skills, aptitude or desire to work on this type of task, based on the information in the database; and, 3) A determination has been made, typically by a human assisted by virtual decision-support services, that these individual entities should form a sub-group within the enterprise.

The organization functions computer 131 shown in FIG. 1 can also include cost and time estimates for the task and provide other information relevant to the task. Cost includes any expense or investment related aspect, versus a more direct benefit (e.g., profit).

In step 221, selected individuals accept or decline or can be accepted or declined by a supervising authority, thereby forming the sub-group. The sub-group can add or cancel members or participants, either with or without the involvement of the organization functions computer. On a more basic level, the maintaining of the database for the sub-group is similar to that of an IRC (internet relay chat) session, in that the listing of current participants and sometimes the status of the participants is maintained. If the change of sub-group membership or participation is accomplished outside of the framework of the organization functions computer, then the changes may be entered into the organization functions computer's database in order to maintain that database current.

Once the sub-group is formed as indicated by step 221, an interim approval of the sub-group can occur, as indicated by step 222 in FIG. 2. This interim approval (as well as the final “approval” cited below in step 233) is actually inherent within the methods disclosed herein, in that the approval is ultimately driven by the ES/SOA metadata, which is itself a dynamic structure. Continuing with step 223 in FIG. 2, the sub-group interacts to address the resolution object. This is one of the advantages of self-synchronization, in that a sub-group can address an issue without the active involvement of the full enterprise or enterprise segment. In doing so, the sub-group may interact, provide decisions, provide identifiers of the action or resolution object, and establish course of action. The sub-group may make resolutions or recommendations. This may include determining and selecting options, making suggestions or proposed resolutions to the resolution object, and performing the actual work that mitigates the resolution object. The sub-group is not confined to its own “default boundaries” and may include the use of otherwise “outside” resources if this is appropriate to the enterprise.

In step 224, a measurement characteristic is identified. Typical measurement characteristics include metrics and indications for progress. The measurement characteristics can be such things as achievements, achievement of milestones and sustainment.

In step 225, criteria for dissolving sub-group are identified. This may be criteria for determining whether the sub-group is sustained or dissolved or a “next step” determination. In some cases, dissolution of the sub-group would be presumed. In other instances a determination would be made, either by the organization functions computer, by the sub-group itself, or by others external of the organization functions computer.

In step 231, a protocol for approval is followed. Often approvals within an enterprise are codified, so it is possible for this to be accomplished with the help of the organization functions computer.

In step 233, the course of action proposed by the sub-group is approved. This can be by communicating a request for approval to cognizant individuals in the enterprise (up to the entire enterprise), or something as simple as a machine approval based on the ability of the organization functions computer to make a determination that the resolution object has been addressed.

In step 241, the organization functions computer monitors the progress of the sub-group. This can be accomplished directly, by use of metrics, or indirectly, by inputs by individuals. The metrics and indications for progress may be used for this purpose, in which case the sub-committee is at least partially self-defining in its function. Thus the function of the organization functions computer would be able to monitor the progress of the sub-group.

In step 243, the organization computer 131 identifies whether criteria have been met to dissolve the sub-group or to sustain the sub-group. This can be achieved directly by the organization functions computer or through input by individuals. Thus the function of the organization computer 131 to monitor the progress of the sub-group can be used to identify whether a critical need such as the resolution object has been met, and whether to dissolve or sustain the sub-group.

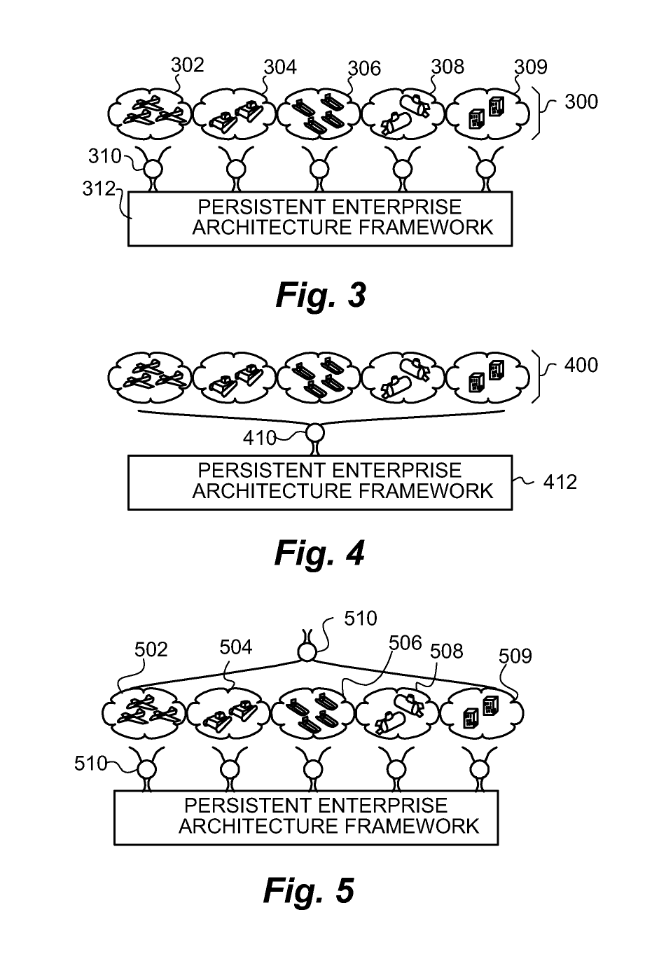

FIGS. 3-10 illustrate several embodiments wherein the LMEB techniques according to several embodiments of the present invention are used in conjunction with sensor networks. Some of the different assets available in the field which are considered and managed using the LMEB in a default organizational mode as individual nodes (also referred to specification as subnets) 300. In FIG. 3, each subnet 300 has a gateway 310 which interacts with a Persistent Enterprise Architecture Framework (PEAF) 312.

FIG. 4 illustrates that when an event is detected, the nodes have the ability to self-synchronize into what is viewed from an enterprise perspective, as a singular entity (node 400) for which there is a single enterprise gateway 410 for the ad-hoc dynamically determined EA/SOA organizational unit (e.g. singular self-synchronized subnet). The subnet 400 interacts with the PEAF 412 through gateway 410 as a single organizational entity while operating internally as a more monolithic and cohesive unit of activity.

FIG. 5 illustrates that the nodes 500 have the ability to identify and monitor conditions so that once a condition is identified as specified by step 243 in FIG. 2, the assets will return to a baseline mode of operation whereby the subnets are more individually managed as nodes 502-509 prior to their reorganization.

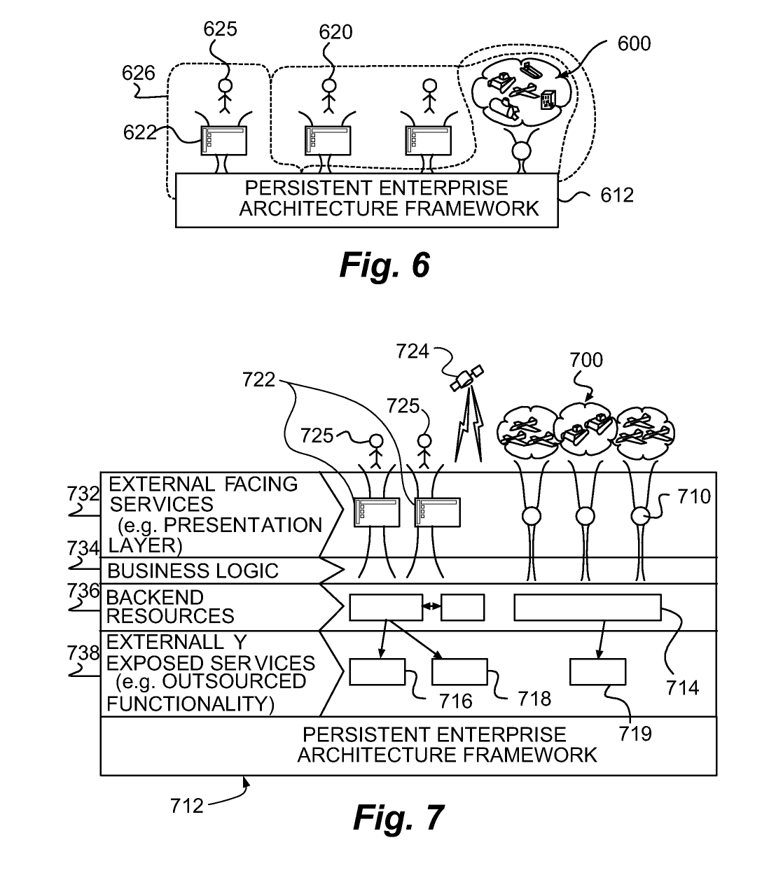

FIG. 6 illustrates a node 600 deployed in the field and the different end users 620 who are interacting with PEAF 612 via their own interface “dashboard” 622 as provided by services within the enterprise presentation layer. Thus, each user has a dashboard to interact with the subnet 600 via the PEAF 612. The diagram illustrates that the organizational boundaries are not strictly localized. Instead, the lifecycle management of organizational boundaries can also include dynamic mission dependent data paths that define a particular “smart sensing” capability to a particular end-user or group of end-users 620. Thus, FIG. 6 illustrates that there may be a dynamically determined organizational unit composed of an end user 620 in the field watching the subnet as well as time sensitive target (TST) subject matter expert (SME) end users 625 monitoring specific mission-dependent features as detected by the mission-objectives associated with the end-to-end mission-dependent data paths from the sensor net resources (nodes 600) to the end-users 620.

The same subnet resource is expected to provide mission dependent resources to other stakeholders and participate in other organizational units. Thus, organizational units “wear many hats” and juggle a number of potentially conflicting objectives. For example, another user 620 (or SME end user 625) may also be concerned with strategy and planning which will also include modeling and simulation, in relation to the state of the environment as detected in the field by the same subnet assets. The dotted line 626 depicts this other organizational unit that is not as easily isolated as self-synchronizing subnets but still uniquely identified and managed by the mission-dependent data paths and associated dependencies with other nodes 600 that are connected to PEAF 612.

FIG. 7 illustrates three different nodes 700 which interface with their respective gateways 710 in the external facing services layer 732 of PEAF 712. These gateways would then talk with a backend resource 736, which in this case can be an internal computer farm 714, as shown in FIG. 7. Other backend resources (e.g., Internal applications, Storage Area Networks (SAN) and internal computing farms) can also interact with different externally exposed services 738. Typical examples of such externally exposed resources include Cloud computing (block 716), Software as a Service (SaaS) (block 718) and Grid computing (block 719) in FIG. 7. To establish communications with offsite users, the backend resources can send data to the field headquarters via a satellite 724 (e.g., Iridium satellite modems) for reach back to the offsite users. Satellite 724 can send the data to other backend resources, which can further communicate information to the users 725 via dashboards 722. Nodes 700 can also self-synchronize to form a single dynamically determined EA/SOA subnet which now interfaces to the backend resources 736 through a single gateway 710.

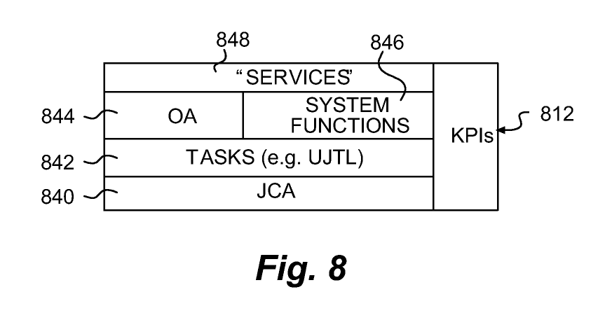

FIG. 8 is a depiction of an exemplary EA/SOA, the Persistent Enterprise Architecture Framework (PEAF), which can be used by the Department of Defense (DoD) as an EA/SOA. At the bottom level there are the Joint Capability Areas (JCA) 840; and tasks, such as Universal Joint Task List (UJTL) 842 depicted in FIG. 8, which is a list of top-level tasks defined by the DoD EA business model, operational activities (OA) 844 and system functions 846 are stacked on JCA as shown in FIG. 8. On the top level there are services 848 which interact with other services. Key Performance Indicators (KPIs) defined by the DoD business model run through all the levels of the PEAF 812.

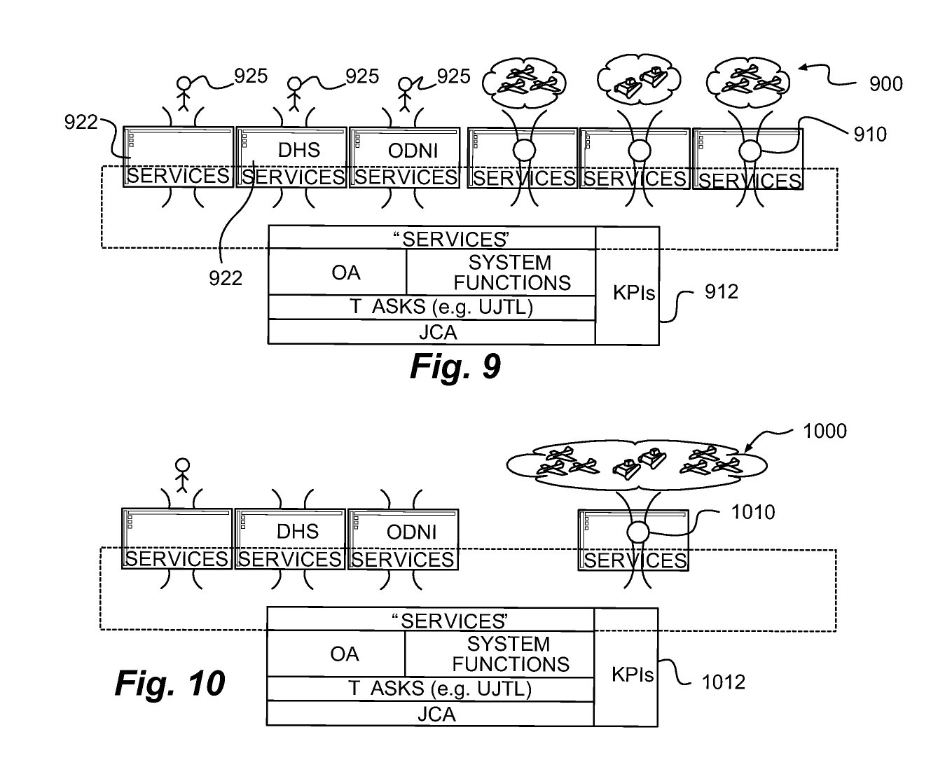

FIGS. 9-10 extend the PEAF to include other entities. Subnets 900 and their respective gateways 910 in the field actually have services which interact with the PEAF 912, as shown in FIG. 9. Other entities such as the “Dashboard” and departments, such as the Office of the Director Of National Intelligence (ODNI) or the Department of Homeland Security (DHS) can also have a dashboards 922 that incorporate a services layer for end users 925 to interact with the PEAF 912. FIG. 10 is the same as FIG. 9 except it illustrates a single dynamically determined EA/SOA subnet 1000 which now interfaces with only one gateway 1010 to the backend resources 738 within PEAF 1012 (See FIG. 10. Please also see FIG. 7).

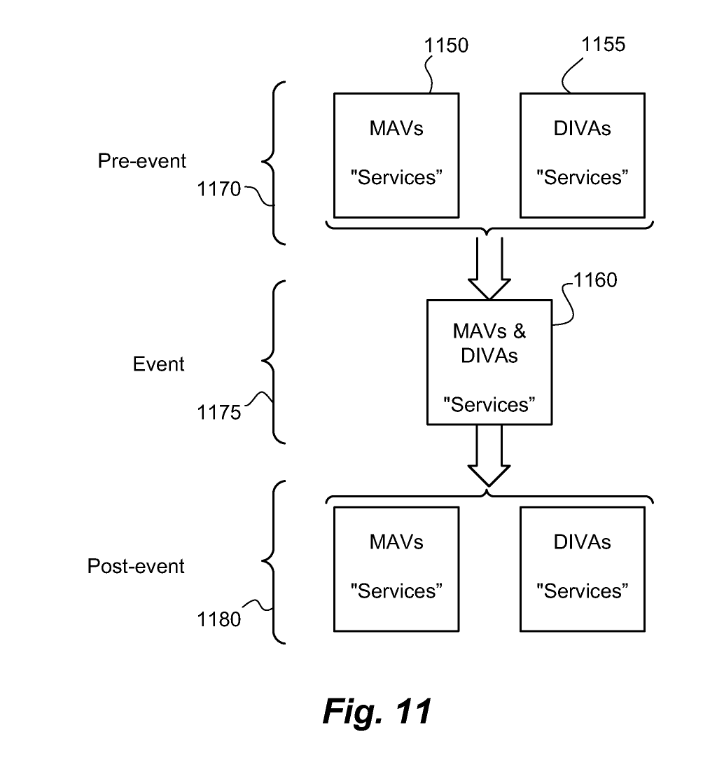

FIG. 11 illustrates the PEAF is present in the event detection scenario, and further describes a scenario wherein all nodes that self-synchronize are sensors instead of groups/sub-groups of people. In this scenario, a set of Micro Aerial Vehicle (MAV) 1150 and Distributed Interactive Video Arrays (DIVA) nodes 1155 are deployed in the field in their baseline mode of operation in the pre-event timeframe 1170. Once the event is detected and the LMEB process described at FIG. 2 occurs during the event timeframe 1175, the MAVs and DIVAs self-synchronize as shown by reference character 1160. Once a condition (criteria for object resolution) has been satisfied, the MAVs and DIVAs will return to their baseline mode of operation in the post-event timeframe 1180.

As an example embodiment of the methods according to several embodiments of the present invention, and referring back to FIG. 3, assume there are a number small vehicles or nodes 300 which can be air nodes 302, ground nodes 304, water nodes 306, underwater nodes 308 for fixed ground nodes 309. Each node 300 has its own pre-assigned tasks (e.g., persistent surveillance). When a node senses an item of interest, a “triggering” event occurs. An alternative triggering event would be a change in priority of objectives, which could come from the top-down, bottom-up or a hybrid hierarchy of command giving a dynamic reorganization capability. Within each individual node is a pre-defined catalog of trajectory management methodologies, techniques and control/management services. The catalog is a collection of objectives that may be a combination of control set points, goal states, business rules, and means of representing the expectations and constraints of that potentially impact the selection of alternative modes for controlling and managing the operation of the node.

In the case that the internal local assessment of the trajectory management mode, relative to the catalog of alternative modes of operation and associated objectives/constraints (e.g. key performance indicators), determines that there is a locally preferred alternative mode, the node will work to transition to the new mode of operation. In the case that the new mode requires a higher degree of more localized coupling within the physical proximity of the node, such as the case for a high precision flying formation of otherwise previously independently operating MAVs, the initiation of the transition to this dynamically determined organizational mode by the prescribed behavior within the new flying mode. For example, some formation initiation protocols are purely distributed and dynamic and will initiate a series of communication transactions to identify potential members of the new formation.

Once the initial node identification process is complete, the nodes may then engage in a negotiation process whereby there is a distributed algorithm that assists resource allocation and local objective conflict-management details. A more centralized formation initiation process may be invoked whereby the initial node notifies a pre-defined node (e.g. move ground nodes 304) of the opportunity to improve performance via a more tightly controlled formation of MAVs. The centralized control node can then reassign a collection of nodes to be the new formation, with one of a number of predefined modes in which they are most optimally controlled relative to the mission objectives, current state of the environment, and available sensor-net resources. More hybrid modes of both decentralized and centralized interactions are additional examples of the open number of other organizational modes that may be within the catalog.

Within the context of this communication, the element level ambiguity is considered to be insignificant due to the global use of a controlled vocabulary or an Enterprise Lexicon Service (ELS) that dynamically provides an assessment of ambiguity while also providing services that dynamically minimize ambiguity that may be dynamically detected in real time. The catalog of organizational modes (e.g. formation flying) includes the lifecycle initiation protocol, management/control, and reversion protocol to a more individually managed default enterprise organizational mode

In addition to the embodiments described above, nodes 300 can incorporate a Multi-Objective Enterprise Optimization Engine (MOEOE), which acts as a reporting service providing information that will in turn supply additional triggering criteria for other nodes 300. The nodes are now able to self synchronize into ad-hoc subnets which are dynamically configured and managed as a more singular EA/SOA node formation which exhibits a new mode of operation. Nodes 300 can further include sensors such as the Video Analysis Content and Extraction eXtensible Smartcamera (VACEXS) and Mission Dependent CODEC (MDC), which is capable of coding and decoding digital data streams or signals. In both cases, the mission-dependent data paths (e.g. associated value-chains) dynamically define the said “devices” (e.g., enterprise sub-net, sensor network, VACEXS, MDC) which are assumed to facilitate accomplishment of individual and collective enterprise goals and objectives. Once the item of interest has been identified the vehicles are then “triggered” or conditions are identified and monitored so that the subnet can self-initiate the return of the self-synchronized subnet to a baseline mode of operation.

The embodiments described herein describe an ability to construct and manage the organization of enterprise architectures such as the PEAF, such that the lifecycle of the nodal topology spans across the entire spectrum of node types and incorporates the ability for collections of nodes (e.g., value chains) to dynamically reorganize through both distributed and centralized, as well as, hybrid means. The examples provided herein illustrate the use of the techniques of several embodiments for managing rapidly deployable intelligence, surveillance and reconnaissance (ISR) sensor networks for ISR applications, as well as with the more human resources oriented enterprise reengineering application domain. Thus, this invention provides a much more unified and cohesive means and method for developing Enterprise Architecture (EA) and associated Service Oriented Architecture (SOA) frameworks, or collections of EA frameworks, such as the PEAF described herein by way of non-limiting example, whereby more efficient and productive value chains are better managed with more dynamic reconfiguration and reorganizational capabilities.

For the sensor-net applications described in FIG. 3-10, the LMEB according to several embodiments of the present invention provides a number of advantages. The example scenario of a constellation of fixed and mobile sensor nodes operating in the field illustrates the ability to utilize a cataloged list of different predefined means and methods for dynamic mission-dependent subnet lifecycle management (e.g. formation, execution, dissolution). The networked sensor subnet subsequently incorporates or dynamically determines and characterizes the enterprise boundaries for the mission-driven value-chain of non-sensor payload carrying nodes (e.g. computational grid/cloud services, end-users). Thus, the self-synchronization behavior of the sensor net applications is a novel improvement over the prior art.

As described above, the mechanisms employed for sensor-net lifecycle management also pertain to other EA application domains such as the more human resources oriented enterprise reengineering and business process/performance management (BPM) domains. Again, the persistent enterprise SOA framework provides the ability to utilize a cataloged list of different predefined means and methods for dynamic mission-dependent subnet lifecycle management (e.g. formation, execution, dissolution) by leveraging EA services that directly support and network the human resources (HR) within the EA framework. Such EA gateways (e.g. Dashboards, workflow-management user interfaces) subsequently help to dynamically determine and characterize the enterprise boundaries for the mission-driven value-chain of HR and non-HR nodes (e.g. sensor-nets, computational grid/cloud services). Thus, for the more HR focused EA application domain, the vision of NCW self-synchronization is also more fully realized than with existing capabilities and associated prior art.

The above two example embodiments and applications illustrate two of an open number of cases where this discovery provides a more unified and coherent means and method for lifestyle management of organizational boundaries. Beyond the advantage of providing a more unified means and method, this discovery also provides the advantage of enabling new EA capabilities, such as illustrated in two complementary disclosures. With this new organizational boundary management capability, the construction and use of a Video Analysis and Content Extraction eXtensible Smartcamera (VACEXS) can be much more readily implemented and utilized. Also, the discovery disclosed herein illustrates the value and utility of a Multi-Objective Enterprise Optimization Engine (MOEOE) where more comprehensive, rigorous, readily useful representations of EA objectives are dynamically analyzed, updated, validated, and certified for potential application by capabilities such as those that employ several of the embodiments of the present invention as described herein.

Conclusion

The use of the terms “a” and “an” and “the” and similar references in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

It will be understood that many additional changes in the details, materials, steps and arrangement of parts, which have been herein described and illustrated to explain the nature of the invention, may be made by those skilled in the art within the principal and scope of the invention as expressed in the appended claims.

1. A method for managing an enterprise, said enterprise including a group of entities that are individuals, sensors or stakeholders, said method comprising the steps of:
A) selecting an infrastructure as a given basis for an enterprise architecture;
B) identifying a discrepancy, problem, need, goal or other task as a resolution object and storing the resolution object in a memory store;
C) using a said processor to determine if the stored resolution object has validity as a resolution object to be addressed by the organization;
D) identifying a sub-group of said entities, said sub-group being defined as part of said infrastructure and including both individuals and sensors, said identifying step being accomplished by said processor using the results of said B);
E) self-synchronizing said sub-group to address said resolution object, said self-synchronizing step being accomplished by said infrastructure using the results of said B) and said step C); and, F) monitoring the progress of the sub-group in the addressing or execution of the resolution object using a predetermined measurement characteristic, said monitoring step being accomplished by said processor using the results of said step E).

2. (canceled)

3. The method of claim 1, further comprising the step of:
J) identifying a metric or indication of progress, and;
K) using the identified metric or indication of progress as the measurement characteristic, said steps J) and K) being accomplished prior to said step F).

4.-7. (canceled)
